(19) United States
(12) Patent Application Publication
(10) Pub. No.: US 2020/0340692 A1
(43) Pub. Date: Oct. 29, 2020

(54) AIR CONDITIONING DEVICE

(71) Applicant: SHARP KABUSHIKI KAISHA, Sakai City, Osaka (JP)

(72) Inventors: TETSUYA IDE, Sakai City, Osaka (JP); MAKOTO YAMADA, Sakai City, Osaka (JP); HIROKA HAMADA, Sakai City, Osaka (JP); SHO OCHI, Sakai City, Osaka (JP); JUN SAKUMA, Sakai City, Osaka (JP); TSUYOSHI KAMADA, Sakai City, Osaka (JP)

(21) Appl. No.: 16/763,503

(22) PCT Filed: Oct. 23, 2018
(86) PCT No.: PCT/JP2018/039321

§ 371 Date: May 12, 2020

(30) Foreign Application Priority Data
Nov. 15, 2017 (JP) 2017-220024

(51) Int. Cl. F24F 3/14; B01D 53/26

(52) U.S. Cl. CPC F24F 3/1417; F24F 1/0358; B01D 53/263

(57) ABSTRACT

An air conditioning device includes: a moisture absorption unit that causes a liquid hygroscopic agent to absorb moisture contained in the air; an atomizing regeneration unit that atomizes the moisture contained in the liquid hygroscopic agent supplied from the moisture absorption unit via a first liquid hygroscopic agent transport flow path, removes the moisture from the liquid hygroscopic agent, and regenerates the liquid hygroscopic agent: an air introduction flow path through which the air is introduced to the moisture absorption unit and the atomizing regeneration unit; a second liquid hygroscopic agent transport flow path through which the liquid hygroscopic agent is transported from the atomizing regeneration unit to the moisture absorption unit; and an air internal pressure rising suppression member that suppresses rising of an internal pressure of the air in the air introduction flow path.

### TECHNICAL FIELD

The present invention relates to an air conditioning device.

This application claims priority based on Japanese Patent Application No. 2017-220024 filed in Japan on Nov. 15, 2017, the content of which is incorporated herein.

### BACKGROUND ART

A humidity control device that controls a humidity of air in a room is conventionally known.

For example, PTL 1 described below discloses a humidity control device that includes two humidity control modules which are configured such that a liquid absorbent and air transfer and receive water vapor through a moisture permeation film, an absorbent circuit in which the liquid absorbent circulates between the two humidity control modules, and a pressure relief valve provided in the absorbent circuit.

PTL 2 described below discloses a dry room device that includes a dehumidifier having an absorption zone and a purge zone, a dry room, a pipe through which air in the dry room is returned to the absorption zone and the purge zone of the dehumidifier, and a flow rate control damper provided in a middle of the pipe.

### CITATION LIST

### Patent Literature

PTL 1: Japanese Unexamined Patent Application Publication No. 2013-133951

PTL 2: Japanese Unexamined Patent Application Publication No. 2014-87761

### SUMMARY OF INVENTION

### Technical Problem

In the humidity control device of PTL 1, when a pressure of the liquid absorbent exceeds an upper limit value, the liquid absorbent is discharged to an outside of the absorbent circuit by the pressure relief valve. Therefore, there is a problem that the liquid absorbent scatters to an outside of the humidity control device.

In the dry room device of PTL 2, the flow rate control damper is provided to prevent intrusion of outer air into the dry room and control a pressure in the dry room. However, in a case where a balance of suction and discharge of air is impaired, for example, the flow rate control damper is difficult to prevent breakage or the like of a gas pipe due to rising of an internal pressure in the pipe.

An aspect of the invention is made to solve the aforementioned problems and an object thereof is to provide an air conditioning device capable of suppressing scattering of a liquid absorbent to an outside in an emergency. Moreover, an object of an aspect of the invention is to provide an air conditioning device capable of suppressing breakage or the like of a gas pipe in an emergency.

### Solution to Problem

In order to achieve the aforementioned objects, an air conditioning device of an aspect of the invention includes: a moisture absorption unit that causes a liquid hygroscopic agent containing a hygroscopic substance to contact air existing in an outer space and to absorb at least a part of moisture contained in the air; a first liquid hygroscopic agent transport flow path through which the liquid hygroscopic agent that absorbs at least the part of the moisture is transported from the moisture absorption unit; an atomizing regeneration unit that atomizes at least a part of the moisture contained in the liquid hygroscopic agent supplied from the moisture absorption unit via the first liquid hygroscopic agent transport flow path, removes at least the part of the moisture from the liquid hygroscopic agent, and regenerates the liquid hygroscopic agent; a second liquid hygroscopic agent transport flow path through which the liquid hygroscopic agent the moisture of which is removed is transported from the atomizing regeneration unit to the moisture absorption unit; an air introduction flow path through which the air existing in the outer space is introduced to the moisture absorption unit and the atomizing regeneration unit; and an air internal pressure rising suppression member that suppresses rising of an internal pressure of the air in the air introduction flow path.

The air conditioning device of an aspect of the invention may further include a backflow suppression member that suppresses backflow of the air or the liquid hygroscopic agent from the atomizing regeneration unit to the air introduction flow path.

In the air conditioning device of an aspect of the invention, the backflow suppression member may interrupt between the atomizing regeneration unit and the air introduction flow path while an operation of the atomizing regeneration unit stops.

The air conditioning device of an aspect of the invention may further include a liquid internal pressure rising suppression member that suppresses rising of an internal pressure of the liquid hygroscopic agent in the first liquid hygroscopic agent transport flow path.

The air conditioning device of an aspect of the invention may further include at least one of a first heat exchange unit that is provided in the first liquid hygroscopic agent transport flow path, includes a first heat transfer promoting structure unit, and performs heat exchange between a heat generation unit and the first liquid hygroscopic agent transport flow path via the first heat transfer promoting structure unit, and a second heat exchange unit that is provided in the second liquid hygroscopic agent transport flow path, includes a second heat transfer promoting structure unit, and performs heat exchange between a heat absorption unit and the second liquid hygroscopic agent transport flow path via the second heat transfer promoting structure unit.

In the air conditioning device of an aspect of the invention, flow resistance of the first liquid hygroscopic agent transport flow path in the first heat exchange unit is larger than flow resistance of the first liquid hygroscopic agent transport flow path in a part other than the first heat exchange unit.

In the air conditioning device of an aspect of the invention, flow resistance of the second liquid hygroscopic agent transport flow path in the second heat exchange unit is larger than flow resistance of the second liquid hygroscopic agent transport flow path in a part other than the second heat exchange unit.

The air conditioning device of an aspect of the invention may further include a flow resistance reducing structure unit or a flow resistance reducing processing unit in the first liquid hygroscopic agent transport flow path in a part other than the first heat exchange unit.

The air conditioning device of an aspect of the invention may further include a flow resistance reducing structure unit or a flow resistance reducing processing unit in the second liquid hygroscopic agent transport flow path in a part other than the second heat exchange unit.

### Advantageous Effects of Invention

According to an aspect of the invention, an air conditioning device capable of suppressing scattering of a liquid absorbent to an outside in an emergency is able to be provided. Moreover, according to an aspect of the invention, an air conditioning device capable of suppressing breakage, damage, or the like of a gas pipe in an emergency is able to be provided.

### BRIEF DESCRIPTION OF DRAWINGS

FIG. 1 illustrates a schematic configuration of an air conditioning device of a first embodiment.

FIG. 2 illustrates a schematic configuration of an air conditioning device of a second embodiment.

FIG. 3 illustrates a schematic configuration of an air conditioning device of a third embodiment.

FIG. 4 is a sectional view of a first heat transfer promoting structure unit in a first liquid hygroscopic agent transport flow path.

FIG. 5 illustrates a schematic configuration of the air conditioning device of the third embodiment.

### DESCRIPTION OF EMBODIMENTS

### First Embodiment

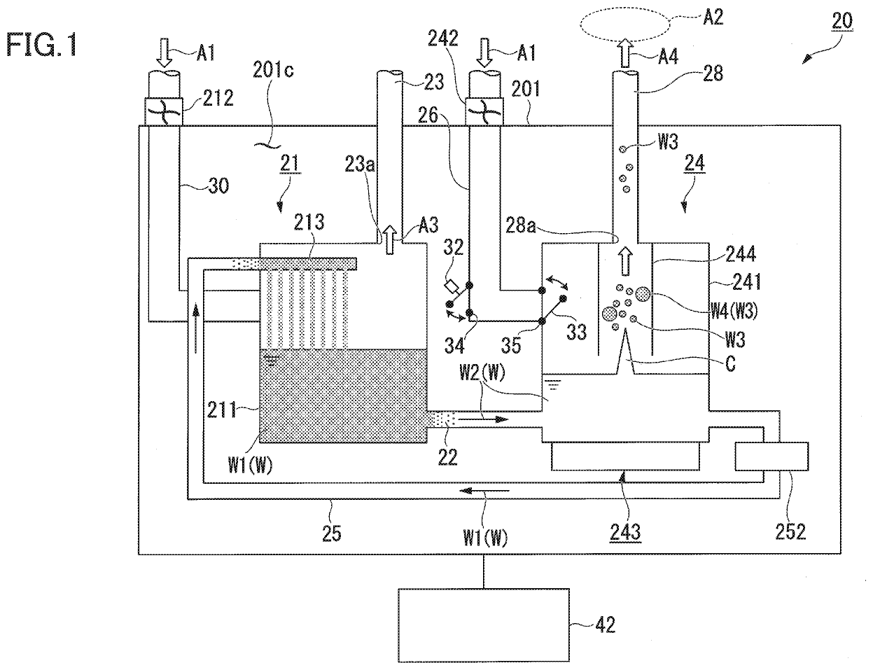

A first embodiment of the invention will be described below with reference to FIG. 1.

FIG. 1 illustrates a schematic configuration of an air conditioning device of the first embodiment.

Note that, in the drawings below, components may be illustrated at different dimensional scales in order to make the components easy to see.

As illustrated in FIG. 1, an air conditioning device 20 of the present embodiment includes a moisture absorption unit 21, an atomizing regeneration unit 24, a first liquid hygroscopic agent transport flow path 22, a second liquid hygroscopic agent transport flow path 25, a first air introduction flow path 30 (air introduction flow path), a second air introduction flow path 26 (air introduction flow path), a pressure release damper 32 (air internal pressure rising suppression member), a backflow prevention damper 33 (backflow suppression member), and a control unit 42. Moreover, the air conditioning device 20 includes a housing 201, and the moisture absorption unit 21 and the atomizing regeneration unit 24 are accommodated in an inner space 201c of the housing 201.

The moisture absorption unit 21 includes a first storage tank 211, a blower 212, and a nozzle 213. The moisture absorption unit 21 causes a liquid hygroscopic agent W that contains a hygroscopic substance to contact air A1 existing in an outer space and to absorb at least a part of moisture contained in the air A1. The moisture absorption unit 21 is desired to cause as much moisture as possible to be absorbed by the liquid hygroscopic agent W, but may cause at least a part of moisture contained in the air A1 to be absorbed by the liquid hygroscopic agent W. The liquid hygroscopic agent W is stored in an inside of the first storage tank 211. The liquid hygroscopic agent W will be described later. To the first storage tank 211, the first air introduction flow path 30, a first air discharge flow path 23, and the first liquid hygroscopic agent transport flow path 22 are connected. The air A1 is supplied by the blower 212 to an inner space of the first storage tank 211 via the first air introduction flow path 30.

The nozzle 213 is arranged in an upper part of the inner space of the first storage tank 211. A liquid hygroscopic agent W1 that is regenerated by the atomizing regeneration unit 24 described later and then returned to the moisture absorption unit 21 via the second liquid hygroscopic agent transport flow path 25 flows down from the nozzle 213 to the inner space of the first storage tank 211, and at this time, the liquid hygroscopic agent W1 and the air A1 contact. Such a form of contact between the liquid hygroscopic agent W1 and the air A1 is typically called a “flow-down system”. Note that, the form of contact between the liquid hygroscopic agent W1 and the air A1 is not limited to the flow-down system and is able to adopt another system. For example, a so-called bubbling system that is a system in which the air A1 made in a bubbled form is supplied into the liquid hygroscopic agent W stored in the first storage tank 211 is also able to be used.

The air A1 existing in the outer space forms an air flow directed from the blower 202 to a discharge port 23a of the first air discharge flow path 23 and contacts the liquid hygroscopic agent W that flows down from the nozzle 213. At this time, at least a part of the moisture contained in the air A1 is absorbed by the liquid hygroscopic agent W and thereby removed. In the moisture absorption unit 21, air obtained by removing moisture from air originally in the room is provided, so that the air is drier than air in an outer space of the air conditioning device 20. In this manner, the dried air is discharged into the room via the first air discharge flow path 23.

The liquid hygroscopic agent W is liquid that has a property (hygroscopicity) of absorbing moisture and is preferably liquid that has hygroscopicity under the conditions of, for example, a temperature of 25° C. and a relative humidity of 50%, and under the atmospheric pressure. The liquid hygroscopic agent W contains a hygroscopic substance described later. Moreover, the liquid hygroscopic agent W may contain a hygroscopic substance and a solvent. As the solvent of this kind, a solvent that dissolves the hygroscopic substance or that is mixed with the hygroscopic substance is used, and an example thereof includes water. The hygroscopic substance may be an organic material or an inorganic material.

Examples of the organic material used as the hygroscopic substance include dihydric or higher alcohol, ketone, an organic solvent having an amide group, saccharides, and a known material used as a raw material for moisturizing cosmetics etc. Among them, the dihydric or higher alcohol, the organic solvent having an amide group, the saccharides, or the known material used as the raw material for moisturizing cosmetics etc. is cited as the organic material suitably used as the hygroscopic substance because of having high hydrophilicity.

Examples of the dihydric or higher alcohol include glycerin, propanediol, butanediol, pentanediol, trimethylolpropane, butanetriol, ethylene glycol, diethylene glycol, and triethylene glycol.

Examples of the organic solvent having an amide group include formamide and acetamide.

Examples of the saccharides include sucrose, pullulan, glucose, xylol, fructose, mannitol, and sorbitol.

Examples of the known material used as the raw material for moisturizing cosmetics etc. include 2-methacryloyloxyethyl phosphoryl choline (MPC), betaine, hyaluronic acid, and collagen.

Examples of the inorganic material used as the hygroscopic substance include calcium chloride, lithium chloride, magnesium chloride, potassium chloride, sodium chloride, zinc chloride, aluminum chloride, lithium bromide, calcium bromide, potassium bromide, sodium hydroxide, and sodium pyrrolidone carboxylate.

In a case where hydrophilicity of the hygroscopic substance is high, for example, when a material of the hygroscopic substance is mixed with water, a ratio of water molecules in a vicinity of a surface (liquid surface) of the liquid hygroscopic agent W is high. The atomizing regeneration unit 24 described later generates an atomized droplet from the vicinity of the surface of the liquid hygroscopic agent W to separate moisture from the liquid hygroscopic agent W. Thus, it is preferable that the ratio of water molecules in the vicinity of the surface of the liquid hygroscopic agent W is high because the moisture is able to be efficiently separated. Moreover, it is preferable that a ratio of the hygroscopic substance in the vicinity of the surface of the liquid hygroscopic agent W is relatively low because a loss of the hygroscopic substance in the atomizing regeneration unit 24 is suppressed.

In the liquid hygroscopic agent W, concentration of a hygroscopic substance contained in the liquid hygroscopic agent W1 used for processing in the moisture absorption unit 21 is not particularly limited, but is preferably 40 mass % or more. When the concentration of the hygroscopic substance is 40 mass % or more, the liquid hygroscopic agent W1 is able to efficiently absorb moisture.

Viscosity of the liquid hygroscopic agent W is preferably 25 mPa·s or less. Thereby, a liquid column C of the liquid hygroscopic agent W is easily generated in the liquid surface of the liquid hygroscopic agent W in the atomizing regeneration unit 24 described later. Thus, the moisture is able to be efficiently separated from the liquid hygroscopic agent W.

The atomizing regeneration unit 24 includes a second storage tank 241, a blower 242, an ultrasonic vibrator 243, and a guide pipe 244. The atomizing regeneration unit 24 atomizes at least a part of moisture contained in a liquid hygroscopic agent W2 supplied from the moisture absorption unit 21 via the first liquid hygroscopic agent transport flow path 22, removes at least the part of the moisture from the liquid hygroscopic agent W2, and thereby regenerates the liquid hygroscopic agent W2. The liquid hygroscopic agent W2 to be regenerated is stored in an inside of the second storage tank 241. To the second storage tank 241, the first liquid hygroscopic agent transport flow path 22, the second liquid hygroscopic agent transport flow path 25, the second air introduction flow path 26, and a second air discharge flow path 28 are connected.

The blower 242 supplies the air A1 from an outer space of the housing 201 to the inside of the second storage tank 241 via the second air introduction flow path 26 and generates an air flow flowing from the inside of the second storage tank 241 to an outside of the housing 201 via the second air discharge flow path 28.

The pressure release damper 32 is provided in a middle of the second air introduction flow path 26 and suppresses rising of an internal pressure of the air A1 in the second air introduction flow path 26. In a case where the internal pressure of the air A1 in the second air introduction flow path 26 is in an allowable range, a load pressure by a weight, a spring, or the like exceeds the internal pressure of the air, so that the pressure release damper 32 is in a closed state. On the other hand, in a case where the internal pressure of the air A1 in the second air introduction flow path 26 is beyond the allowable range, for example, such as a case where the backflow prevention damper 33 described later malfunctions, the internal pressure of the air exceeds the load pressure and the pressure release damper 32 is in an opened state. Moreover, a packing 34 by which a sealing property in the second air introduction flow path 26 is kept is provided around the pressure release damper 32.

The backflow prevention damper 33 is provided in a part where the second air introduction flow path 26 is connected to the second storage tank 241 and suppresses backflow of the air A1 from the atomizing regeneration unit 24 to the second air introduction flow path 26 or intrusion of the liquid hygroscopic agent W2. For example, in a case where the atomizing regeneration unit 24 normally operates, the backflow prevention damper 33 is in the opened state and allows the air A1 to enter the atomizing regeneration unit 24. On the other hand, in an abnormality, for example, such as in a case where the operation of the atomizing regeneration unit 24 stops, the backflow prevention damper 33 is in the closed state and interrupts between the atomizing regeneration unit 24 and the second air introduction flow path 26.

Thereby, the second storage tank 241 is sealed and backflow of the air A1 or intrusion of the liquid hygroscopic agent W2 is suppressed. Further, a packing 35 by which the sealing property in the second air introduction flow path 26 is kept is provided around the backflow prevention damper 33. Moreover, the backflow prevention damper 33 is configured to be opened in an upper side of the damper and is thus able to suppress leakage due to a splash of the liquid hygroscopic agent W2.

The ultrasonic vibrator 243 irradiates the liquid hygroscopic agent W2 with an ultrasonic wave to thereby generate an atomized droplet W3, which contains moisture, from the liquid hygroscopic agent W2. The ultrasonic vibrator 243 is provided in contact with a bottom plate of the second storage tank 241. When the ultrasonic vibrator 243 irradiates the liquid hygroscopic agent W2 with the ultrasonic wave, by adjusting a condition for generating the ultrasonic wave, a liquid column C of the liquid hygroscopic agent W2 is able to be generated in a liquid surface of the liquid hygroscopic agent W2. Many atomized droplets W3 are generated from the liquid column C of the liquid hygroscopic agent W2.

Through the guide pipe 244, the atomized droplet W3 generated from the liquid hygroscopic agent W2 is guided to a discharge port 28a of the second air discharge flow path 28. When the air conditioning device 20 is viewed from above, the guide pipe 244 is provided so as to surround the discharge port 28a.

Through the second air discharge flow path 28, air A4 that contains the atomized droplet W3 is discharged to the outer space of the housing 201 and removed from an inside of the air conditioning device 20. This makes it possible to separate the moisture from the liquid hygroscopic agent W2. As a result, hygroscopic performance of the liquid hygroscopic agent W2 is enhanced again and the liquid hygroscopic agent W2 is able to be returned to the moisture absorption unit 21 and reused. The air A4 contains the atomized droplet W3 generated in the inside of the second storage tank 241 and is thus wetter than air A2 in the outer space of the housing 201. In this manner, the humidified air A4 is discharged into the room via the second air discharge flow path 28. Note that, the backflow prevention damper 33 may be provided in a part where the second air discharge flow path 28 is connected to the second storage tank 241. This makes it possible to prevent backflow of the air A4 to the second storage tank 241.

Since the discharge port 28a is overlapped with the ultrasonic vibrator 243 in plan view when the atomizing regeneration unit 24 is viewed from above, the liquid column C of the liquid hygroscopic agent W2 is generated below the discharge port 28a. Thus, the atomizing regeneration unit 24 is designed such that the guide pipe 244 surrounds the liquid column C generated in the liquid hygroscopic agent W2. When the discharge port 28a, the guide pipe 244, and the liquid column C have such a positional relationship, the atomized droplet W3 generated from the liquid column C of the liquid hygroscopic agent W2 is guided to the discharge port 28a by an air flow directed upwardly from the liquid surface of the liquid hygroscopic agent W2.

The moisture absorption unit 21 and the atomizing regeneration unit 24 are connected by the first liquid hygroscopic agent transport flow path 22 and the second liquid hygroscopic agent transport flow path 25 that form a circulation flow path of the liquid hygroscopic agent W. A pump 252 by which the liquid hygroscopic agent W circulates is provided in a middle of the second liquid hygroscopic agent transport flow path 25.

Through the first liquid hygroscopic agent transport flow path 22, the liquid hygroscopic agent W that absorbs at least a part of moisture is transported from the moisture absorption unit 21 to the atomizing regeneration unit 24. One end of the first liquid hygroscopic agent transport flow path 22 is connected to a lower part of the first storage tank 211. A part where the first liquid hygroscopic agent transport flow path 22 is connected to the first storage tank 211 is positioned below a liquid surface of the liquid hygroscopic agent W1 in the first storage tank 211. On the other hand, the other end of the first liquid hygroscopic agent transport flow path 22 is connected to a lower part of the second storage tank 241. A part where the first liquid hygroscopic agent transport flow path 22 is connected to the second storage tank 241 is positioned below the liquid surface of the liquid hygroscopic agent W2 in the second storage tank 241.

Through the second liquid hygroscopic agent transport flow path 25, the liquid hygroscopic agent W that is regenerated by the moisture being removed is transported from the atomizing regeneration unit 24 to the moisture absorption unit 21. One end of the second liquid hygroscopic agent transport flow path 25 is connected to a lower part of the second storage tank 241. A part where the second liquid hygroscopic agent transport flow path 25 is connected to the second storage tank 241 is positioned below the liquid surface of the liquid hygroscopic agent W2 in the second storage tank 241. On the other hand, the other end of the second liquid hygroscopic agent transport flow path 25 is connected to an upper part of the first storage tank 211. A part where the second liquid hygroscopic agent transport flow path 25 is connected to the first storage tank 211 is positioned above the liquid surface of the liquid hygroscopic agent W1 in the first storage tank 211 and is connected to the nozzle 213 described above.

It has been described above that, in the air conditioning device 20, dehumidified air is discharged from the moisture absorption unit 21 via the first air discharge flow path 23 and humidified air is discharged from the atomizing regeneration unit 24 via the second air discharge flow path 28. In a case where the air conditioning device 20 of the present embodiment is an air conditioning device having only a dehumidification function as a humidity control function, for example, a configuration in which an air discharge port of the first air discharge flow path 23 is arranged to be directed to an inside of the room and an air discharge port of the second air discharge flow path 28 is arranged to be directed to an outside of the room may be adopted. Further, in a case of an air conditioning device having only a humidification function, for example, a configuration in which the air discharge port of the second air discharge flow path 28 is arranged to be directed to the inside of the room and the air discharge port of the first air discharge flow path 23 is arranged to be directed to the outside of the room may be adopted. Further, in a case of an air conditioning device having both the dehumidification function and the humidification function, a configuration in which the air discharge ports of both the first air discharge flow path 23 and the second air discharge flow path 28 are arranged to be directed to the inside of the room and the control unit 42 performs control about from which of the air discharge ports air is to be discharged may be adopted.

In the air conditioning device 20 of the present embodiment, for example, even when a balance of suction and discharge of air in the atomizing regeneration unit 24 is impaired and an internal pressure of the second air introduction flow path 26 or the second storage tank 241 rises, provision of the pressure release damper 32 enables suppression of occurrence of a defect such as breakage or damage of a pipe of the second air introduction flow path 26. Moreover, provision of the backflow prevention damper 33 enables suppression of backflow of air or a liquid hygroscopic agent. Existence of the pressure release damper 32 and the backflow prevention damper 33 enables enhancement of safety and reliability of the air conditioning device 20.

Moreover, since the packings 34 and 35 are respectively provided around the pressure release damper 32 and the backflow prevention damper 33, a sealing property of the second storage tank 241 is enhanced so that consumption of the liquid hygroscopic agent W due to evaporation, entering of dust, or the like is able to be suppressed.

Moreover, the backflow prevention damper 33 is arranged at a position close to a position where the liquid column C of the liquid hygroscopic agent W2 is formed, but is configured to be opened in an upper side, and is thus able to suppress intrusion of the liquid hygroscopic agent W2 into the second air introduction flow path 26 due to a liquid splash from the liquid column C.

### Second Embodiment

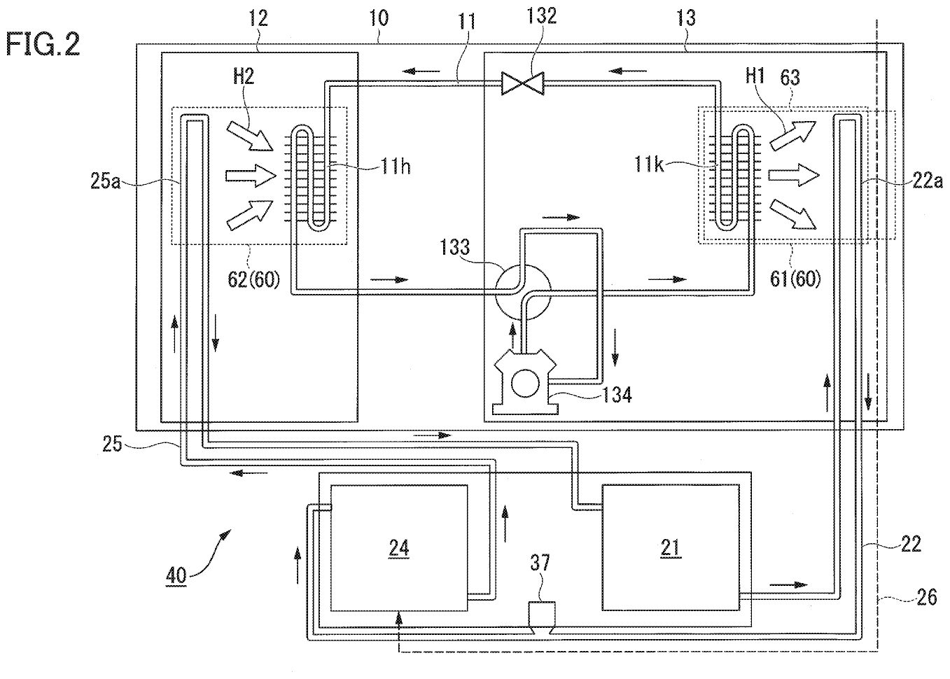

An air conditioning device of a second embodiment will be described below with reference to FIG. 2.

The air conditioning device of the second embodiment has the same basic configuration as that of the first embodiment and is different from that of the first embodiment in that heat exchange is performed between a heat pump of an air conditioner for temperature control in a room and a liquid hygroscopic agent transport flow path of the air conditioning device and that a liquid internal pressure rising suppression member is provided.

FIG. 2 illustrates a schematic configuration of the air conditioning device of the second embodiment.

In FIG. 2, a component common with that of the drawing used in the first embodiment will be denoted by the same reference sign, and description thereof will be omitted.

In the present embodiment, in addition to an air conditioning device 40, a component related to an air conditioner for temperature control 10 is illustrated in FIG. 2.

As illustrated in FIG. 2, the air conditioning device 40 of the present embodiment includes the moisture absorption unit 21, the atomizing regeneration unit 24, the first liquid hygroscopic agent transport flow path 22, the second liquid hygroscopic agent transport flow path 25, and a buffer container 37 (liquid internal pressure rising suppression member).

The buffer container 37 is provided in a middle of the first liquid hygroscopic agent transport flow path 22 and suppresses rising of an internal pressure of the liquid hygroscopic agent in the first liquid hygroscopic agent transport flow path 22. The buffer container 37 includes a pressure release valve (not illustrated). An inner space of the buffer container 37 communicates with an inner space of the first liquid hygroscopic agent transport flow path 22. Thereby, when the internal pressure of the liquid hygroscopic agent is beyond an allowable range, the liquid hygroscopic agent in the first liquid hygroscopic agent transport flow path 22 is able to be stored in the buffer container 37.

The air conditioner for temperature control 10 includes an indoor unit 12, an outdoor unit 13, and a heat pump 11. The heat pump 11 includes, in addition to a pipeline in which a heat medium circulates, an expansion valve 132, a four-way valve 133, a compressor 134, and the like. The expansion valve 132, the four-way valve 133, and the compressor 134 are accommodated in an inside of the outdoor unit 13.

The pipeline of the heat pump 11 includes an indoor-side coil 11h (indoor-side pipeline) accommodated in an inside of the indoor unit 12 and an outdoor-side coil 11k (outdoor-side pipeline) accommodated in the inside of the outdoor unit 13.

The air conditioning device 40 of the present embodiment further includes a liquid hygroscopic agent heat exchange unit 60 that performs heat exchange at least either between a part of the pipeline of the heat pump 11 and the first liquid hygroscopic agent transport flow path 22 or between a part of the pipeline of the heat pump 11 and the second liquid hygroscopic agent transport flow path 25. The liquid hygroscopic agent heat exchange unit 60 includes a first liquid hygroscopic agent heat exchange unit 61 and a second liquid hygroscopic agent heat exchange unit 62. The first liquid hygroscopic agent heat exchange unit 61 performs heat exchange between the outdoor-side coil 11k (heat generation unit) of the heat pump 11 and a part 22a of the first liquid hygroscopic agent transport flow path 22 during cooling in the room. The second liquid hygroscopic agent heat exchange unit 62 performs heat exchange between the indoor-side coil 11h (heat absorption unit) of the heat pump 11 and a part 25a of the second liquid hygroscopic agent transport flow path 25 during cooling in the room.

In the first liquid hygroscopic agent heat exchange unit 61, heat H1 released from the heat medium in the heat pump 11 is absorbed by the liquid hygroscopic agent in the first liquid hygroscopic agent transport flow path 22 during cooling in the room, so that the temperature of the liquid hygroscopic agent rises as compared to that before the heat exchange. On the other hand, in the second liquid hygroscopic agent heat exchange unit 62, heat H2 of the liquid hygroscopic agent in the second liquid hygroscopic agent transport flow path 25 is absorbed by the heat medium in the heat pump 11 during cooling in the room, so that the temperature of the liquid hygroscopic agent falls as compared to that before the heat exchange.

Note that, though an example in which the liquid hygroscopic agent heat exchange unit 60 includes both the first liquid hygroscopic agent heat exchange unit 61 and the second liquid hygroscopic agent heat exchange unit 62 is indicated in the present embodiment, the liquid hygroscopic agent heat exchange unit 60 may include at least one of the first liquid hygroscopic agent heat exchange unit 61 and the second liquid hygroscopic agent heat exchange unit 62. In particular, from a viewpoint of effectively utilizing exhaust heat of the heat medium, the liquid hygroscopic agent heat exchange unit 60 is desired to include the first liquid hygroscopic agent heat exchange unit 61. That is, it is sufficient that the liquid hygroscopic agent heat exchange unit 60 performs heat exchange at least either between a part of the pipeline (heat exhaust side) of the heat pump 11 and the first liquid hygroscopic agent transport flow path 22 or between a part (heat absorption side) of the pipeline of the heat pump 11 and the second liquid hygroscopic agent transport flow path 25.

As described above, in the air conditioning device including the first liquid hygroscopic agent heat exchange unit 61, heat released from the heat medium in the heat pump 11 is absorbed by the liquid hygroscopic agent in the first liquid hygroscopic agent transport flow path 22, so that the temperature of the liquid hygroscopic agent rises as compared to that before the heat exchange. Thereby, the liquid hygroscopic agent is thermally expanded and the internal pressure of the liquid hygroscopic agent in a liquid pipe of the first liquid hygroscopic agent transport flow path 22 rises. As a result, the liquid pipe of the first liquid hygroscopic agent transport flow path 22 may be broken or damaged.

On the other hand, in the air conditioning device 40 of the present embodiment, the buffer container 37 is provided in the first liquid hygroscopic agent transport flow path 22. Therefore, when the internal pressure of the liquid hygroscopic agent is beyond the allowable range due to thermal expansion of the liquid hygroscopic agent or the like, the liquid hygroscopic agent in the first liquid hygroscopic agent transport flow path 22 flows into an inside of the buffer container 37, so that rising of the internal pressure of the liquid hygroscopic agent is suppressed. Thereby, occurrence of a defect such as breakage or damage of the liquid pipe of the first liquid hygroscopic agent transport flow path 22 is able to be suppressed without scattering the liquid hygroscopic agent to an outside of the device. Existence of the buffer container 37 is able to enhance safety and reliability of the air conditioning device 40.

Further, a specific effect of the air conditioning device 40 of the present embodiment will be described.

A relationship between a liquid temperature and an atomization amount of the liquid hygroscopic agent typically indicates characteristics that the atomization amount of moisture contained in the liquid hygroscopic agent is reduced as the liquid temperature of the liquid hygroscopic agent is low, and the atomization amount of the moisture contained in the liquid hygroscopic agent is increased as the liquid temperature of the liquid hygroscopic agent is high. Thus, in order to enhance performance of regenerating the liquid hygroscopic agent by increasing the atomization amount of the moisture, the liquid temperature of the liquid hygroscopic agent supplied from the moisture absorption unit 21 to the atomizing regeneration unit 24 is preferably high. From this point of view, the air conditioning device 40 of the present embodiment includes the first liquid hygroscopic agent heat exchange unit 61 and the liquid temperature of the liquid hygroscopic agent supplied to the atomizing regeneration unit 24 is able to be made high, so that the performance of regenerating the liquid hygroscopic agent is able to be enhanced.

On the other hand, in order to enhance hygroscopic performance of the liquid hygroscopic agent in the moisture absorption unit 21, the liquid temperature of the liquid hygroscopic agent supplied from the atomizing regeneration unit 24 to the moisture absorption unit 21 is preferably low. From this point of view, the air conditioning device 40 of the present embodiment includes the second liquid hygroscopic agent heat exchange unit 62 and the liquid temperature of the liquid hygroscopic agent supplied to the moisture absorption unit 21 is able to be made low, so that the hygroscopic performance of the liquid hygroscopic agent is able to be enhanced.

Moreover, as illustrated in FIG. 2, the air conditioning device 40 of the present embodiment may further include an air heat exchange unit 63 that performs heat exchange between the outdoor-side coil 11k of the heat pump 11 and the second air introduction flow path 26 during cooling in the room. According to such a configuration, the temperature of the air supplied to the atomizing regeneration unit 24 is higher than that before the heat exchange, so that atomizing efficiency is enhanced and the performance of regenerating the liquid hygroscopic agent is able to be enhanced.

### Third Embodiment

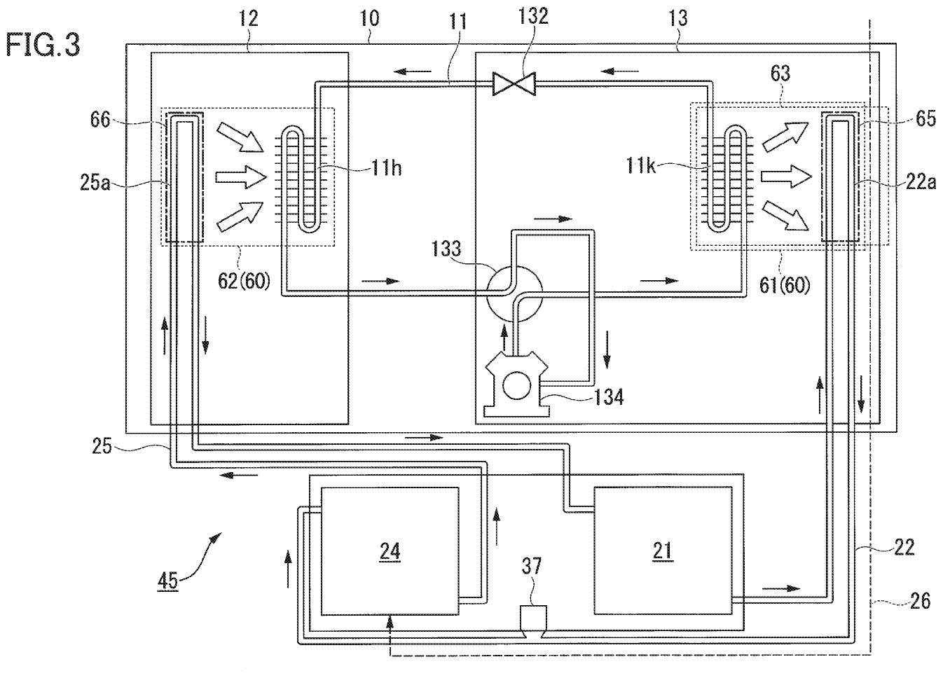

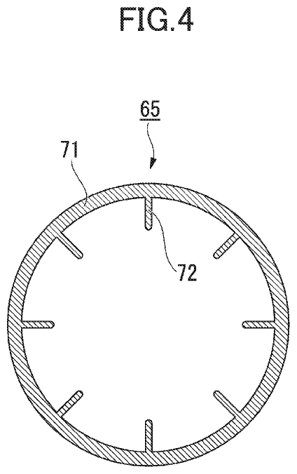

An air conditioning device of a third embodiment will be described below with reference to FIGS. 3 and 4.

The air conditioning device of the third embodiment has the same basic configuration as that of the second embodiment and is different from that of the second embodiment in a configuration of a liquid hygroscopic agent transport flow path.

FIG. 3 illustrates a schematic configuration of the air conditioning device of the third embodiment. FIG. 4 is a sectional view of a first heat transfer promoting structure unit in the first liquid hygroscopic agent transport flow path.

In FIG. 3, a component common with that of FIG. 2 used in the second embodiment will be denoted by the same reference sign, and description thereof will be omitted.

As illustrated in FIG. 3, an air conditioning device 45 of the present embodiment includes the first liquid hygroscopic agent heat exchange unit 61 (first heat exchange unit) that is provided in the first liquid hygroscopic agent transport flow path 22, includes a first heat transfer promoting structure unit 65, and performs heat exchange between the outdoor-side coil 11k (heat generation unit) and the first liquid hygroscopic agent transport flow path 22 via the first heat transfer promoting structure unit 65.

Moreover, the air conditioning device 45 of the present embodiment includes the second liquid hygroscopic agent heat exchange unit 62 (second heat exchange unit) that is provided in the second liquid hygroscopic agent transport flow path 25, includes a second heat transfer promoting structure unit 66, and performs heat exchange between the indoor-side coil 11h (heat absorption unit) and the second liquid hygroscopic agent transport flow path 25 via the second heat transfer promoting structure unit 66.

As illustrated in FIG. 4, the first heat transfer promoting structure unit 65 is constituted by an extended heat transfer surface including a plurality of fins 72 that are projected from an inner wall of a liquid pipe 71 to an inside. Since such a kind of first heat transfer promoting structure unit 65 is provided in the first liquid hygroscopic agent heat transfer unit 61, flow resistance of the first liquid hygroscopic agent transport flow path 22 in the first liquid hygroscopic agent heat exchange unit 61 is larger than flow resistance of the first liquid hygroscopic agent transport flow path 22 in a part other than the first liquid hygroscopic agent heat exchange unit 61.

Moreover, similarly to the first heat transfer promoting structure unit 65, the second heat transfer promoting structure unit 66 is constituted by an extended heat transfer surface including a plurality of fins. Thereby, flow resistance of the second liquid hygroscopic agent transport flow path 25 in the second liquid hygroscopic agent heat exchange unit 62 is larger than flow resistance of the second liquid hygroscopic agent transport flow path 25 in a part other than the second liquid hygroscopic agent heat exchange unit 62.

Similarly to the second embodiment, the air conditioning device 45 of the present embodiment includes the buffer container 37 provided in the first liquid hygroscopic agent transport flow path 22. The other configuration of the air conditioning device 45 is similar to that of the air conditioning device 40 of the second embodiment.

Also in the present embodiment, effects similar to those of the second embodiment that the buffer container 37 allows suppression of breakage, damage, or the like of the liquid pipe of the first liquid hygroscopic agent transport flow path 22 and allows enhancement of safety and reliability of the air conditioning device 45 are obtained.

Moreover, in a case of the present embodiment, since each of the first heat transfer promoting structure unit 65 and the second heat transfer promoting structure unit 66 is provided in the liquid pipe of the liquid hygroscopic agent heat transfer unit 60, heat exchange with heat exhausted from the air conditioner for temperature control 10 is able to be highly efficiently performed while a loss of flow in the liquid pipe is suppressed to a minimum. A reason therefor is that each of the first heat transfer promoting structure unit 65 and the second heat transfer promoting structure unit 66 is constituted by the extended heat transfer surface, so that an area where the liquid hygroscopic agent and the liquid pipe contact increases and turbulence of the liquid hygroscopic agent easily occurs and heat conductivity is improved.

Note that, in the present embodiment, each of the first heat transfer promoting structure unit 65 and the second heat transfer promoting structure unit 66 may be constituted by, in addition to the extended heat transfer surface described above, surface and fluidic oscillation, a bent and curved pipe, or the like. When the surface and fluidic oscillation or the bent and curved pipe is used, laminar flow of the liquid hygroscopic agent flowing in the pipe is disrupted and turbulence easily occurs, so that heat conductivity is improved. As a result, heat exchange with heat exhausted from the air conditioner for temperature control 10 is able to be highly efficiently performed.

### Fourth Embodiment

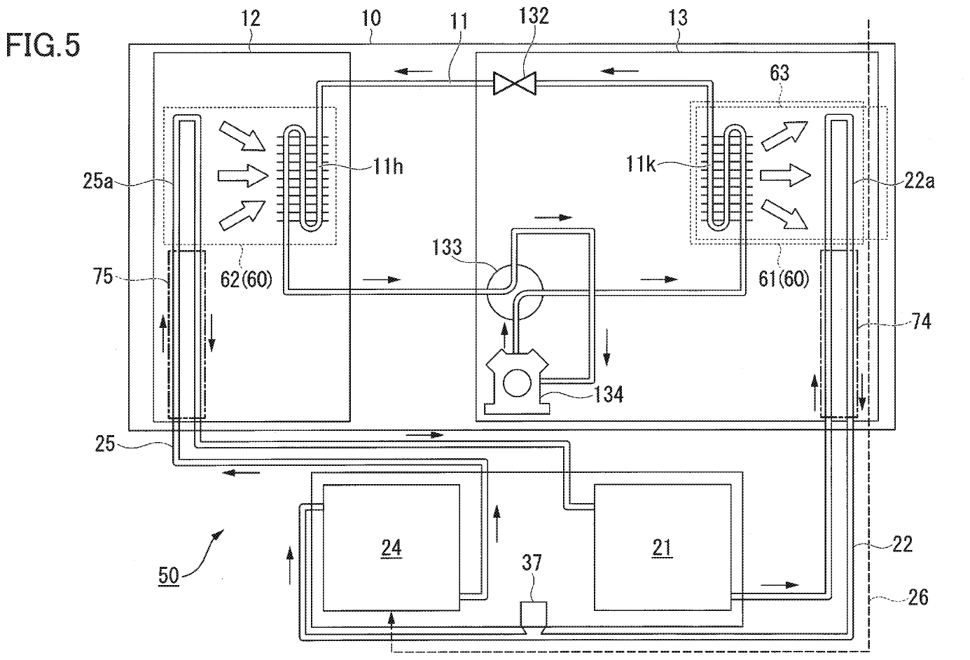

An air conditioning device of a fourth embodiment will be described below with reference to FIG. 5.

The air conditioning device of the fourth embodiment has the same basic configuration as that of the second embodiment and is different from that of the second embodiment in a configuration of a liquid hygroscopic agent transport flow path.

FIG. 5 illustrates a schematic configuration of the air conditioning device of the fourth embodiment.

In FIG. 5, a component common with that of FIG. 2 used in the second embodiment will be denoted by the same reference sign, and description thereof will be omitted.

As illustrated in FIG. 5, an air conditioning device 50 of the present embodiment has a flow resistance reducing structure unit 74 in the first liquid hygroscopic agent transport flow path 22 in a part other than the first liquid hygroscopic agent heat exchange unit 61. Alternatively, a flow resistance reducing processing unit may be provided instead of the flow resistance reducing structure unit 74.

Moreover, the air conditioning device 50 of the present embodiment has a flow resistance reducing structure unit 75 in the second liquid hygroscopic agent transport flow path 25 in a part other than the second liquid hygroscopic agent heat exchange unit 62. Alternatively, a flow resistance reducing processing unit may be provided instead of the flow resistance reducing structure unit 75. The other configuration of the air conditioning device 50 is similar to that of the air conditioning device of the second embodiment.

Each of the flow resistance reducing structure units 74 and 75 is constituted, for example, by a fine uneven structure formed on an inner wall surface of the liquid pipe. Thereby, water repellency is provided to the inner wall surface of the liquid pipe and flow resistance of the liquid hygroscopic agent is reduced. Moreover, the flow resistance reducing processing unit is constituted by, for example, a pipe friction reduction agent that is applied to the inner wall surface of the liquid pipe and contains a surfactant. Thereby, occurrence of turbulence in a vicinity of the inner wall surface of the liquid pipe is suppressed and a friction loss is reduced.

Also in the present embodiment, effects similar to those of the second embodiment that the buffer container 37 allows suppression of breakage, damage, or the like of the liquid pipe of the first liquid hygroscopic agent transport flow path 22 and allows enhancement of safety and reliability of the air conditioning device 50 are obtained.

Moreover, in a case of the present embodiment, since the flow resistance reducing structure units 74 and 75 are respectively provided in a part of the first liquid hygroscopic agent transport flow path 22 and a part of the second liquid hygroscopic agent transport flow path 25, heat exchange with heat exhausted from the air conditioner for temperature control is able to be highly efficiently performed while a loss of flow in the liquid pipe is suppressed to a minimum. A reason therefor is that the flow resistance reducing structure units 74 and 75 are able to form pseudo-laminar flow even when the liquid hygroscopic agent flows under a turbulence condition.

Moreover, in the case of the present embodiment, the flow resistance of the liquid hygroscopic agent is reduced, so that load of a pump that transports the liquid hygroscopic agent is able to be reduced.

Note that, a technical scope of the invention is not limited to the aforementioned embodiments and may be variously modified in a range not departing from the concept of the invention.

For example, though an example in which the air conditioning device of the first embodiment includes the pressure release damper (air internal pressure rising suppression member) and the backflow prevention damper (backflow suppression member) in the air introduction flow path and the air conditioning device of the second embodiment includes the buffer container (liquid internal pressure rising suppression member) in the liquid hygroscopic agent transport flow path is indicated, an air conditioning device of an aspect of the invention may include both at least one of the air internal pressure rising suppression member and the backflow suppression member, and the liquid internal pressure rising suppression member.

Moreover, arrangement of the moisture absorption unit and the atomizing regeneration unit that form the air conditioning device is not particularly limited, and, for example, the moisture absorption unit and the atomizing regeneration unit may be arranged side by side in a horizontal direction or the moisture absorption unit and the atomizing regeneration unit may be arranged so as to be stacked in a vertical direction

### INDUSTRIAL APPLICABILITY

The invention is able to be utilized for an air conditioning device used for air conditioning in a room.

1. An air conditioning device comprising:
a moisture absorption unit that causes a liquid hygroscopic agent containing a hygroscopic substance to contact air existing in an outer space and to absorb at least a part of moisture contained in the air;
a first liquid hygroscopic agent transport flow path through which the liquid hygroscopic agent that absorbs at least the part of the moisture is transported from the moisture absorption unit;
an atomizing regeneration unit that atomizes at least a part of the moisture contained in the liquid hygroscopic agent supplied from the moisture absorption unit via the first liquid hygroscopic agent transport flow path, removes at least the part of the moisture from the liquid hygroscopic agent, and regenerates the liquid hygroscopic agent;
a second liquid hygroscopic agent transport flow path through which the liquid hygroscopic agent the moisture of which is removed is transported from the atomizing regeneration unit to the moisture absorption unit;
an air introduction flow path through which the air existing in the outer space is introduced to the moisture absorption unit and the atomizing regeneration unit; and
an air internal pressure rising suppression member that suppresses rising of an internal pressure of the air in the air introduction flow path.

2. The air conditioning device according to claim 1, further comprising a backflow suppression member that suppresses backflow of the air or the liquid hygroscopic agent from the atomizing regeneration unit to the air introduction flow path.

3. The air conditioning device according to claim 2, wherein the backflow suppression member interrupts between the atomizing regeneration unit and the air introduction flow path while an operation of the atomizing regeneration unit stops.

4. The air conditioning device according to claim 1, further comprising a liquid internal pressure rising suppression member that suppresses rising of an internal pressure of the liquid hygroscopic agent in the first liquid hygroscopic agent transport flow path.

5. The air conditioning device according to claim 1, further comprising at least one of
a first heat exchange unit that is provided in the first liquid hygroscopic agent transport flow path, includes a first heat transfer promoting structure unit, and performs heat exchange between a heat generation unit and the first liquid hygroscopic agent transport flow path via the first heat transfer promoting structure unit, and
a second heat exchange unit that is provided in the second liquid hygroscopic agent transport flow path, includes a second heat transfer promoting structure unit, and performs heat exchange between a heat absorption unit and the second liquid hygroscopic agent transport flow path via the second heat transfer promoting structure unit.

6. The air conditioning device according to claim 5, wherein flow resistance of the first liquid hygroscopic agent transport flow path in the first heat exchange unit is larger than flow resistance of the first liquid hygroscopic agent transport flow path in a part other than the first heat exchange unit.

7. The air conditioning device according to claim 5, wherein flow resistance of the second liquid hygroscopic agent transport flow path in the second heat exchange unit is larger than flow resistance of the second liquid hygroscopic agent transport flow path in a part other than the second heat exchange unit.

8. The air conditioning device according to claim 5, further comprising a flow resistance reducing structure unit or a flow resistance reducing processing unit in the first liquid hygroscopic agent transport flow path in a part other than the first heat exchange unit.

9. The air conditioning device according to claim 5, further comprising a flow resistance reducing structure unit or a flow resistance reducing processing unit in the second liquid hygroscopic agent transport flow path in a part other than the second heat exchange unit.
